(19) United States
(12) Patent Application Publication
(10) Pub. No.: US 2011/0310071 A1
(43) Pub. Date: Dec. 22, 2011

(54) ENERGY EFFICIENT DISPLAY SYSTEM

(75) Inventors: Christopher A. Segall, Camas, WA (US); Louis Joseph Kerofsky, Camas, WA (US)

(73) Assignee: SHARP LABORATORIES OF AMERICA, INC., Camas, WA (US)

(21) Appl. No.: 12/817,579

(22) Filed: Jun. 17, 2010

(51) Int. Cl. G09G 3/36; G09G 5/00

(52) U.S. Cl. 345/207; 345/102

(57) ABSTRACT

A display for that includes an ambient light sensor suitable to receive ambient light such that the display modifies its power usage based upon the amount of light sensed by the ambient light sensor. An energy interface receives an energy signal from a location remote to the display indicative of energy usage. The energy interface, in response to the energy signal, modifies the amount of light received by the ambient light sensor.

### CROSS-REFERENCE TO RELATED APPLICATIONS

Not applicable.

### BACKGROUND OF THE INVENTION

The present invention relates generally to an energy efficient display system.

There is a desire among consumers of televisions to watch television content while also being environmentally conscious by reducing the resulting power consumption of the television. In the context of smart grid linked operation, televisions receive signals from a smart meter grid or an energy manager, and adjust their operation accordingly. In response to receiving such signals, generally two types of actions are taken. The first action is a time shifting where the television schedules its operation to occur during off peak times. The second action is a demand responsive reduced load operation where the power drawn by the television is reduced by lowering its performance level.

What is desired is an energy efficient display system responsive to an external input related to energy usage.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a system for reducing power consumption.

FIG. 2 illustrates another system for reducing power consumption.

### DETAILED DESCRIPTION OF PREFERRED EMBODIMENT

In an attempt to make televisions (or any display device) more energy efficient, the principal focus has been on improving device efficiency when in use. Unfortunately, in many cases such improved device efficiency may be insufficient to reach the power reductions desired. Accordingly, in some situations, aggressive power consumption reduction may be desired, e.g., in response to load reduction information from a smart meter, and/or energy meter, and/or central server.

Under an aggressive power reduction mode, a television is usually dramatically dimmed by reducing the maximum luminance to a lower value. For backlit liquid crystal televisions (LCD), the luminance reduction may be achieved by a reduction in the backlight luminance For plasma or organic light emitting diode based displays, the luminance may be reduced by reducing the power consumed by the active display elements. Other display technologies may reduce power consumption using similar techniques. Power reduction may likewise be achieved by modifying the image processing technique, such as increasing the transmisivity of the liquid crystal material while decreasing different portions of the backlight (e.g., light emitting diode based backlights).

The power reduction system for a television may include techniques for making the television responsive to a smart meter, connected to smart electricity grid, for providing one or more power savings modes. The power savings mode may include modified video processing, backlight reduction techniques, and/or power savings by suitable audio processing. In the context of smart grid linked operation, the television receives signals from a smart meter grid, a central server (e.g., any suitable computing device), and/or an energy manager, and adjusts its operation accordingly. In general, two types of actions are taken in response to signals from the smart meter, energy manager, and/or the central server. The first type of action is a time shifting of its operations so that activities occur during off peak times. The second type of action is to reduce the power drawn by the appliance by lowering its performance level.

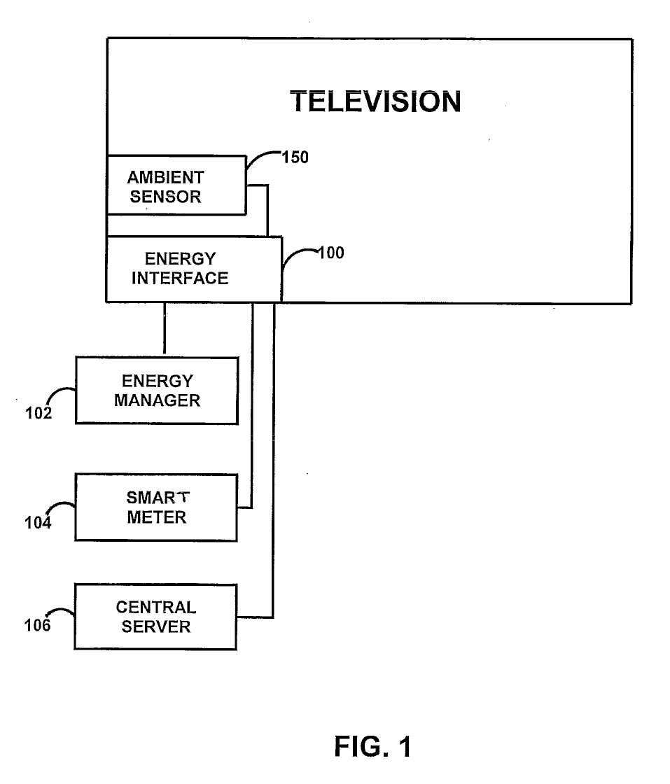

Referring to FIG. 1, the television may communicate though an energy interface 100 with an energy manager 102 and/or a smart meter 104 and/or a central server 106 (all generally referred to as an energy device). The energy interface 100 may be any suitable device and/or functional part associated with the television. Any suitable communication protocol may be used, such as for example, WiFi, Ethernet, powerline, and/or ZigBee. Data from the energy interface 100 may be used to modify the power usage of television and/or associated devices.

The energy interface 100, rather than being directly interconnected within the display to modify its power usage, is interconnected to an ambient sensor 150, which in turn modifies the power usage of the television and/or associated devices. The ambient sensor 150 senses the ambient lighting levels associated with the television. Based upon the level of the ambient light detected by the sensor 150, the power management features of the television may be adjusted, such as for example, the display brightness, the rendering techniques, and associated devices such as audio speakers. For example, with bright ambient lighting the backlight may be increased so that the display is easier to view. For example, with dim ambient lighting the backlight may be decreased so that the display saves power. In general, as a result of input from the ambient sensor 150, the television determines, at least in part, sufficient display brightness or other power savings modifications.

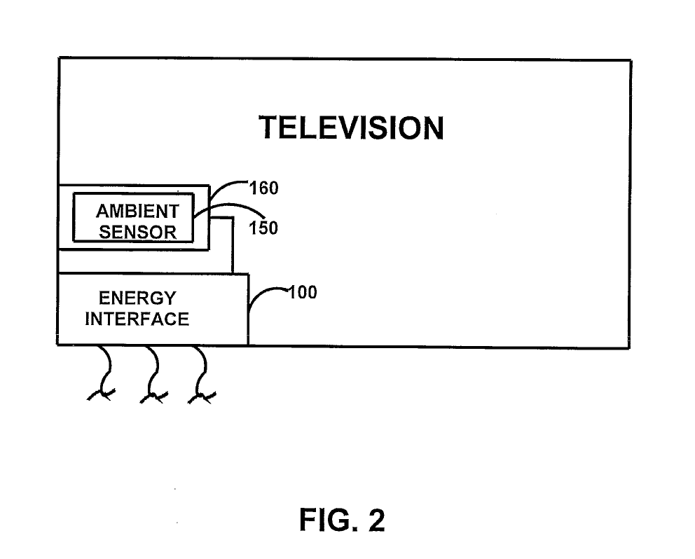

Referring to FIG. 2, the amount of light detected by an ambient light sensor 150 incorporated with the television may be further controlled by a selective light element 160. When the energy interface 100 receives a signal from an event, then the light element 160 may be modified to change the amount of light received by the ambient sensor 150. This facilitates control of the power usage of the display albeit in an indirect manner.

When an event is detected, the light detected by the ambient sensor 150 is preferably attenuated by the light element 160. When the amount of light detected by the ambient sensor 150 is decreased by the light element, the television reduces its brightness and, as a result, its power consumption. When an event is not detected, the light element 160 does not similarly attenuate the light detected by the ambient sensor 150. In the case that it is desired to use the ambient light sensor 150 for other functions, the light element permits the ambient sensor 150 to detect the ambient light in its normal fashion. In the case that it is not desired to use the ambient light sensor 150 for other functions, a constant light input may be provided to the ambient light sensor 150.

Accordingly, when the energy interface 100 receives a signal indicating an event or otherwise an indication that it is desirable to reduce (or increase) power usage, the light element 160 attenuates the amount of light that is detected by the ambient light sensor 150. The television then decreases power by reducing its brightness. Alternatively, when the energy interface 100 does not receive a signal indicating an event, the light element 160 does not attenuate the amount of light that is detected by the ambient sensor 150. The television then returns to its normal power consumption.

There are many different embodiments that may be used to implement the combination of the energy interface 100 and light element 160. One embodiment of the light element 160 includes liquid crystal material. When an event is received, the liquid crystal material attenuates the light passed to the ambient light sensor 150. When an event is not received, the liquid crystal material does not similarly attenuate the light passed to the ambient light sensor 150.

In another embodiment, the light element 160 may be a mechanical device, such as a shutter or iris. When an event is received, the mechanical device closes and therefore attenuates the light passed to the ambient light sensor 150. When an event is not received, the device opens and does not similarly attenuate the light passed to the ambient light sensor 150.

In another embodiment, the light element 160 is a light emitting element. When an event is received, the light output of the light emitting element is decreased. This decreases the light detected by the ambient light sensor 150. When an event is not received, the light output of the light emitting element is increased. This increases the light detected by the ambient light sensor 150.

In another embodiment, the light element 160 is a combination of a light emitting element and a second ambient light sensor. When an event is received, the light output of the light emitting element is decreased. This decreases the light detected by the first ambient light sensor. When an event is not received, the light output of the light emitting element is controlled by the light detected by the second ambient light sensor.

In another embodiment, the light element 160 is a combination of a light emitting element and a second ambient light sensor. When an event is received, the light output of the light emitting element is decreased. When an event is not received, the light output of the light emitting element is increased.

In another embodiment, a user selects if the light output of a light emitting element is a function of the light detected by a second ambient light sensor or if the light output of the light emitting element is a constant. This allows a user to use the ambient light sensor for additional functionality, or to disable the additional functionality while still using the ambient light sensor for responding an to event.

In another embodiment, if an event is detected it performs processing to determine the correct input to the ambient light sensor 150, and then transmits this information to the light element 160. The transmission of information to the light element 160 may be performed by an internal memory or data bus, an external memory or data bus, a wireless link, or other mechanism.

In another embodiment, the light element 160 detects an event by a wired data connection. For example, the DR event may be detected by transmission over an Ethernet network or RS-485 network.

In another embodiment, the light element detects an event by a wireless data connection. For example, the DR event may be detected by transmission over a ZigBee, Blutooth or 802.11x network.

In another embodiment, the light element provides a visible indicator that an event is detected.

In another embodiment, the light element provides an override mode. When the override mode is enabled, the light element 160 does not change its output when an event is detected. Instead, the device operates as if an event was not detected.

In another embodiment, the light detected by the ambient light sensor 150 when an event is detected is controlled by the user. The user may use any mechanism to control the device, such as a switch, keypad, computer program or mobile internet device to control the value.

In another embodiment, the light detected by the ambient light sensor 150 when an event is not detected is controlled by the user. The user may use any mechanism to control the device, such as a switch, keypad, computer program or mobile internet device to control the value.

In another embodiment, an override mode is configured by the user. The user may use any mechanism to control the device, such as a switch, keypad, computer program or mobile internet device to control the value.

In another embodiment, when an event or no event is first detected, the device does not change the light level detected by the ambient light sensor instantaneously. Instead, the change is made gradually over time using any technique.

In another embodiment, the television incorporates a solar cell to provide power to the device. In the event that the display device and the energy interface are separate devices or otherwise separate enclosures, the solar cell for powering the energy interface may have a solar cell to provide power thereto.

In another embodiment, the television uses a solar cell as the second ambient light sensor.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A display for displaying an image comprising:
(a) an ambient light sensor suitable to receive ambient light such that said display modifies its power usage based upon the amount of light sensed by said ambient light sensor;
(b) an energy interface that receives an energy signal from a location remote to said display indicative of energy usage;
(c) said energy interface, in response to said energy signal, modifying the amount of light provided to said ambient light sensor.

2. The display of claim 1 wherein said energy signal is from an energy manager.

3. The display of claim 1 wherein said energy signal is from a smart meter.

4. The display of claim 1 wherein said energy signal is from a central server.

5. The display of claim 1 wherein said energy signal is from an energy device.

6. The display of claim 1 wherein said modified power usage is by decreasing the luminance of a backlight of said display.

7. The display of claim 1 wherein said modified power usage is by decreasing the power usage by associated speakers for said display.

8. The method of claim 1 wherein said modifying is as a result of a light attenuating device.

9. The method of claim 1 wherein said light attenuating device reduces light reaching said ambient light sensor.

10. The method of claim 1 wherein said modifying is as a result of modifying a light emitting element providing illumination to said ambient light sensor.

11. The method of claim 1 wherein said modifying is as a result of modifying a liquid crystal material.

12. The method of claim 1 wherein said modifying is as a result of modifying at least one of a mechanical shutter and an iris.

13. The method of claim 1 wherein said modifying is as a result of a second ambient light sensor.

14. The method of claim 1 further comprising a visible indicator of said energy signal.

15. The method of claim 1 wherein said modifying the amount of light provided to said ambient light sensor is a first mode of operation, and further comprising a second mode of operation that may be selectively selected wherein said modifying does not occur as a result of said energy signal.
